(19) United States
(12) Patent Application Publication
(10) Pub. No.: US 2010/0088065 A1
(43) Pub. Date: Apr. 8, 2010

(54) METHOD FOR ASSESSING PROPERTIES OF FIBRE CEMENT BOARD

(76) Inventor: Armin Thumm, Rotorua (NZ)

Correspondence Address: JACOBSON HOLMAN PLLC, 400 SEVENTH STREET N.W., SUITE 600, WASHINGTON, DC, 20004, US

(21) Appl. No.: 12/448,756

(22) PCT Filed: Dec. 18, 2007
(86) PCT No.: PCT/NZ2007/000369

§ 371 Date: Nov. 23, 2009

(30) Foreign Application Priority Data
Jan. 4, 2007 (NZ) 550317

(51) Int. Cl. G06F 17/18

(52) U.S. Cl. 702/179

(57) ABSTRACT

The invention is also its method of use for assessing fibre-cement board in order to predict the fibre content of the board, to predict the moisture content of the board, or to predict mechanical properties of the board comprising: a source of near infra red radiation; a near-infrared detector for obtaining a near-infrared spectra, the detector being mounted in association with a size roll; and means for predicting the fibre content of the board, the moisture content of the board, or the mechanical properties of the board by reference to the near-infrared spectra obtained.

### FIELD OF THE INVENTION

This invention relates to a method for predicting, during processing, properties of fibre-cement product using near-infrared spectroscopy.

### BACKGROUND

Fibre cement products, for example fibre-cement board, are widely used in the building and construction industries for external cladding and internal linings. Particular applications include exterior cladding, eaves and soffits, and internal wall linings or ceilings, tile underlays, and pipes.

Fibre-cement products, such as fibre-cement board, generally comprise a cementitious binder, aggregate, organic fibres, density modifiers, and various additives to improve different material properties. However, not all these ingredients are necessary to form a suitable fibre-cement board. For example, the formulation may simply comprise cementitious binder and organic fibres.

Fibre-cement products may be manufactured using a number of conventional processes. Examples of conventional processes are: the Hatschek process, the Mazza pipe process, the Magnani process, injection moulding, extrusion, hand lay-up, moulding, casting, filter pressing, fourdrinier forming, multi-wire forming, gap blade forming, gap roll/blade forming, bel-roll forming, wellcrete, and others. In the Hatschek process an aqueous slurry of cement, silica, unbleached kraft fibres and other additives is dewatered on a screen cylinder and vacuum felt. The green sheet is then hydrothermally cured at temperatures of 150-190° C.

During manufacture of fibre-cement board, it is necessary to continuously achieve a correct fibre loading or product mix to ensure a consistent product is produced. It is known to assess the final product by wet chemistry and/or physical testing. However, a disadvantage of these traditional testing methodologies is that they are destructive. Another disadvantage is the time lapse between manufacture and testing, which may result in product manufactured that does not meet specification.

Techniques based on near-infrared (NIR) spectroscopy are used to determine the properties of different materials. For example, NIR is used for controlling the purity of chemicals and pharmaceuticals, and the on-line quality control of moisture content in butter and other dairy products.

Infrared absorption is used to determine the moisture content and fibre weight of paper as described in EP 0 518 39. Electromagnetic, laser or microwave detection are used to measure and control the distribution of fibres in paper or board as described in WO 99/42656. NIR is used in the pulp and paper industry for parameters such as kappa number, pulp yield or consistency (Lindgren T, Edlund U (1998) Prediction of lignin content and pulp yield from black liquor using near-infrared spectroscopy and partial least square regression. Nord Pulp Pap. Res. J. 9(1):76-80). Other uses of NIR are for measuring the octane number in petroleum products as described in U.S. Pat. No. 5,360,972, and segregation of plastic wastes for recycling as described in U.S. Pat. No. 5,510,619.

It is an object of at least preferred embodiments of the invention to provide a method for predicting properties of fibre-cement board on-line and in real time, and/or to at least provide the public with a useful choice.

### SUMMARY OF THE INVENTION

In accordance with a first aspect of the present invention, there is provided a method for assessing a fibre-cement product in order to predict the fibre content of the product, to predict the moisture content of the product, or to predict mechanical properties of the product comprising: obtaining a near-infrared spectra; and predicting the fibre content of the product, the moisture content of the product, or the mechanical properties of the product by reference to the near-infrared spectra obtained.

The term ‘comprising’ as used in this specification means ‘consisting at least in part of, that is to say when interpreting statements in this specification which include that term, the features, prefaced by that term in each statement, all need to be present but other features can also be present.

Preferably, the method includes subjecting the fibre-cement product to a source of near-infrared radiation, detecting the levels of reflected radiation over the near-infrared range or at a number of wavelengths in the near-infrared range, and analyzing the near-infrared reflectance spectra relative to stored comparative information on near-infrared reflectance data for fibre-cement product.

By radiation in the near-infrared region is meant radiation of wavelength(s) in the range 1100-2500 nm.

Preferably, the near-infrared spectra are obtained while the fibre-cement product is in a green state.

Preferably, the method includes assigning weighted factors to the spectra obtained and predicting the fibre content, moisture content, or mechanical properties by comparing the weighted factor to known weighted factors.

Preferably, the fibre-cement product is a fibre-cement board.

Preferably, the near-infrared spectra are obtained during manufacture when the thickness of the board is building up from a number of layers.

Preferably, the mechanical properties predicted are modulus of rupture or fracture toughness.

In accordance with a second aspect of the present invention, there is provided a method for assessing fibre-cement board in order to predict the fibre content of the board, to predict the moisture content of the board, or to predict mechanical properties of the board comprising: obtaining a near-infrared spectra while the thickness of the board is building up from a number of layers; and predicting the fibre content of the board, the moisture content of the board, or the mechanical properties of the board by reference to the near-infrared spectra obtained.

In accordance with a third aspect of the present invention, there is provided a method for assessing fibre-cement board in order to predict the fibre content of the board, to predict the moisture content of the board, or to predict mechanical properties of the board comprising: obtaining a near-infrared spectra while the thickness of the board is building up from a number of layers on a size roll; and predicting the fibre content of the board, the moisture content of the board, or the mechanical properties of the board by reference to the near-infrared spectra obtained.

In accordance with a fourth aspect of the present invention, there is provided an apparatus for assessing fibre-cement board in order to predict the fibre content of the board, to predict the moisture content of the board, or to predict mechanical properties of the board comprising: a source of near infra red radiation; a near-infrared detector for obtaining a near-infrared spectra, the detector mounted in association with a size roll; and means for predicting the fibre content of the board, the moisture content of the board, or the mechanical properties of the board by reference to the near-infrared spectra obtained.

Preferably, the apparatus includes means for analyzing the near-infrared reflectance spectra relative to stored comparative information on near-infrared reflectance data for fibre-cement board.

Preferably, the apparatus may further comprise means for assigning weighted factors to the spectra obtained and predicting the fibre content, moisture content or the mechanical properties by comparing the weighted factor to known weighted factors.

Preferably, the mechanical properties predicted are modulus of rupture or fracture toughness.

The invention consists in the foregoing and also envisages constructions of which the following gives examples only.

### BRIEF DESCRIPTION OF THE DRAWINGS

The present invention will now be described with reference to the accompanying drawings in which:

FIG. 1 shows an NIR probe mounted directly above a size roll;

FIG. 2 shows spectra of green fibre-cement boards from three different manufacturing runs;

FIG. 3 shows a predicted vs. measured graph for the fibre content regression model;

FIG. 4 predicted vs. measured graph for moisture content regression model;

FIG. 5 shows a graph of fibre content prediction based on entirely dry boards;

FIG. 6 shows measured vs. predicted graph for cross-directional modulus of rupture (MoR) at equilibrium moisture content (EMC); and

FIG. 7 shows a measured vs. predicted graph for cross-directional fracture toughness at EMC.

### DETAILED DESCRIPTION

Fibre-cement products, for example fibre-cement board, are manufactured by forming an aqueous slurry of a cementitious binder, an aggregate, organic fibre, and water. However, not all these ingredients are necessary to form a suitable fibre-cement product. For example, the formulation may simply comprise cementitious binder and organic fibres.

A range of reinforcing fibres and mixtures of fibres may be used, for example, asbestos, glass fibres, synthetic organic fibres (e.g., PVA) and various cellulose-containing fibres. Mixtures of fibre types are also used. Near infra red spectra may be obtained and analyzed for fibre-cement products with cellulose-containing fibres and other organic fibres, and blends containing one or more of these fibres.

One or more other chemicals or additives may be added to the slurry. For example, organic or inorganic density modifiers, viscosity modifiers, fire retardants, waterproofing agents, silica fume, geothermal silica, thickeners, pigments, colorants, plasticizers, dispersants, forming agents, flocculent, drainage aids, wet and dry strength aids, silicone materials, aluminum powder, clay, kaolin, alumina trihydrate, mica, metakaolin, calcium carbonate, wollastonite, or polymeric resin emulsion.

An example of a common manufacturing process to make fibre-cement board is the Hatschek sheet process. In this process, the aqueous slurry is dewatered on sieve rolls and transported along a felt conveyor where further water is removed by vacuum. The high-solids sheet is then transferred to the rotating size roll where a number of layers are accumulated until the target board thickness is reached. Pressure is applied to the size roll to remove moisture from the board. The board is cut using a cutting wire into predetermined lengths. Another conveyor transfers the board to a pile. At this pre-cured stage, the board is known as a green board or sheet. The green sheets are pre-cured at ambient or elevated temperatures. Final curing of the sheet can then be accomplished by air curing, typically for approximately 30 days, or by autoclaving at an elevated temperature and pressure in a steam-saturated atmosphere for 3-30 hours.

In the preferred method of the invention, near-infrared spectra are obtained while the thickness of the board is building up on the size roll. This allows the spectra, through the thickness of the board, to be obtained on-line and in real time and allows the quality of the end product to be predicted during production. However, the spectra may be obtained at other points in the manufacturing process, such as on the conveyor between the size roll and the pile of green or uncured sheets. Alternatively, the spectra may be obtained from the final cured sheet.

The near-infrared spectra is obtained by subjecting the fibre-cement board to a source of near-infrared radiation. By radiation in the near-infrared region is meant radiation of wavelengths) in the range 1100-2500 nm. The levels of absorbed radiation over the near-infrared range or at a number of wavelengths in the near-infrared range are detected by a suitable detector.

The near-infrared reflectance spectra are analyzed relative to stored comparative information on near-infrared reflectance data for fibre-cement board. In the preferred method of the invention, weighted factors are assigned to the spectra obtained and compared to known weighted factors.

The near-infrared spectra obtained from the green sheet can be used to predict the fibre content of the board, to predict the moisture content of the board, or to predict mechanical properties of the board. The near-infrared spectra obtained may be used to predict the modulus of rupture, fracture toughness, or other mechanical properties.

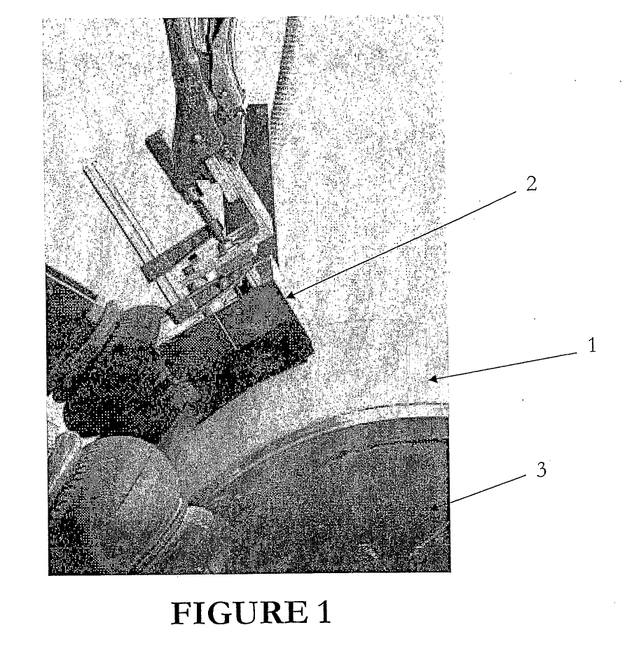

Referring to FIG. 1, a preferred arrangement for obtaining spectra from a green sheet 1 is shown. The apparatus comprises a source of near-infrared radiation and a detector system. The detector 2 is mounted above the size roll 3 in a fibre-cement board production line. This allows the apparatus to obtain spectra on-line and in real time. The apparatus shown in FIG. 1 is a Foss 6500 NIR spectrometer, which is a laboratory instrument. However, there is a wide range of instruments available which have been designed for industry use and which have a performance equal or better to the instrument used here (e.g., Matrix-F from Bruker Optics or Corona from Zeiss).

The invention is further illustrated by the following description of trial results.

### The Trials

Two trials were run to assess the effect of varying the fibre content on the performance of the fibre-cement composite sheets using two different pulps. The following example presents the results of this assessment of the ability of NIR spectroscopy, measured on the green sheet, to predict the fibre content of the sheet, the moisture content of the green sheet, and also the flexural performance of the final cured sheet.

Two different trials were used to assess the potential of the NIR technique. The trials were independent of each other in the respect that they were on different days and were using new materials each time. In the first trial the same fibre was used for 4 different runs each with a different fibre loading. The target fibre loadings were 6%, 7%, 8% and 9%. Material from the first trial was also examined by NIR after oven drying. This was done to examine the influence of moisture content on the fibre content prediction. In the second trial the first run was a reference run at 8% fibre loading which was using the same fibre as in the first trial. Then a different fibre was used in three further runs at target loadings of 8%, 7% and 9%.

During each run of the second trial the pressure applied to the sizing roll was reduced twice to create a change in moisture content of the sheets. The following schedule was used:

TABLE 1
Schedule for size role pressure

| Sheet No | Pressure, kPa | Comments |
|---|---|---|
| 1-7 | 1,020 (normal) | not assessed |
| 8-12 | 1,020 | assessed |
| 13 | normal to low | transitional sheet, not |
| | | assessed |
| 14-15 | 510 (low) | assessed |
| 16 | low to very low | transitional sheet, not |
| | | assessed |
| 17-18 | 260 (very low) | assessed |

Not all runs had sufficient material for the full schedule of size roll variation but all runs provided sheets from the first size roll pressure reduction.

### Spectra Acquisition

For the purpose of this trial the NIR probe was mounted directly above the size roll with a distance between the blank size roll and the detector of 10 mm, in a configuration as shown in FIG. 1.

The detector continuously accumulated scans while the sheet built up to its final thickness. This means an average measurement was obtained which is representative of the whole thickness of the sheet. In this trial 90 scans were accumulated in a period of 70 seconds. The NIR instrument was set to obtain a spectrum of the full NIR range with each scan, i.e., from 1100-2500 nm. Spectra were recorded against an internal ceramic standard which was renewed before each run.

### Data Analysis

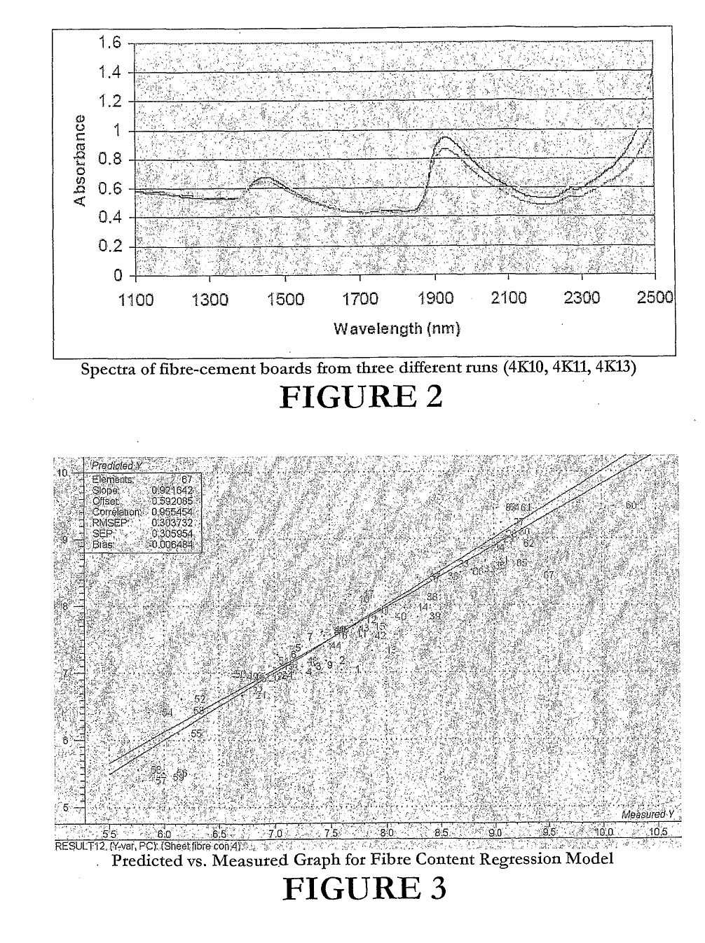

The data obtained from the NIR instrument is an NIR spectrum. This spectrum is the response of the material to NIR light broken down into individual wavelengths in the recorded range. Some typical spectra from fibre-cement boards can be seen in FIG. 2. The data was analyzed by computer-based multivariate analysis (MVA) techniques.

The spectra used to predict (e.g., fibre content) consist of 700 individual data points (wavelengths). In a regression 700 data points (independent variable) are not used against a single dependant data point (fibre content). Multivariate analysis (MVA) replaces the 700 data points with highly compressed artificial variables. In these “artificial variables” each wavelength is assigned a certain importance based on how strongly its covariance is with other wavelength for this specific artificial variable, e.g., changes in fibre content will causes systematic changes in the spectra at certain wavelengths. One of the compressed artificial variables will pick up these systematic changes and will assign high importance to all wavelengths that change with fibre content. All other wavelength will be assigned lower importance. In MWA-speak a weighting is applied to the wavelength based on their covariance within a certain compressed variable. The compressed variables are usually called Principal Components or Factors.

Accordingly with the MVA all (700) data points of a spectrum are thus used to predict a few physical values, e.g., moisture content or fibre content. MVA creates artificial variables called Factors or Principal Components. These Principal Components apply a weighting to each wavelength based on their covariance. If a certain constituent, for example fibre loading, changes from sample to sample this will cause covariant changes in the spectra. These covariant changes can then be identified by one or several Principal Components and this information is used to predict future unknown samples.

The outcome of the MVA process is a regression model which has the NIR spectrum as an input and predicted physical variables as an output. The quality of this regression model can be assessed by predicting known samples and calculating the prediction error. For small sample sets (such as this) this is most commonly done by a process called cross validation.

For small sample sets (such as this) this is most commonly done by a process called cross validation. For cross validation a small number of samples is removed from the data set as a test set and the rest is used to make a model which then predicts the previously removed samples. Then the removed samples are put back in the main data set and a new test set of different samples is removed and the process repeated. This is done until all samples have been used in a test set. The statistical data from all the test sets are then averaged to give the cross validation prediction error*. * the cross validation prediction error is sometimes abbreviated as RMSECV=Root Mean Square Error of Cross Validation or simply as RMSEP=Root Mean Square Error of Prediction

The data sets from the two trials were combined before regressing them against the measurements of fibre content, MC, flexural strength and FT, except for the analysis of different moisture contents which could only be performed on the data from the second trial.

### Results

The combined spectroscopic data from both trials were regressed against the fibre content data which had been obtained via carbon analysis. FIG. 3 gives a visual impression of the regression results using a predicted vs. measured graph.

In a predicted vs measured graph values are predicted more accurately the closer they are to the target line which has a slope of 1. In a perfect model all predicted values would fall on the target line. Usually however, there is a certain amount of scatter around the target line as can be seen in FIG. 3. If the values are scattered evenly around the target line there is no bias in the prediction. In this case however there is a slight tendency for values to be underpredicted which causes a small negative bias. One line in the graph is the regression line which has a slope of 0.92. This slope, which is smaller than 1, indicates that high values will be (slightly) underpredicted. Overall, the prediction of fibre content is good with a prediction error of 0.3%, based on cross validation.

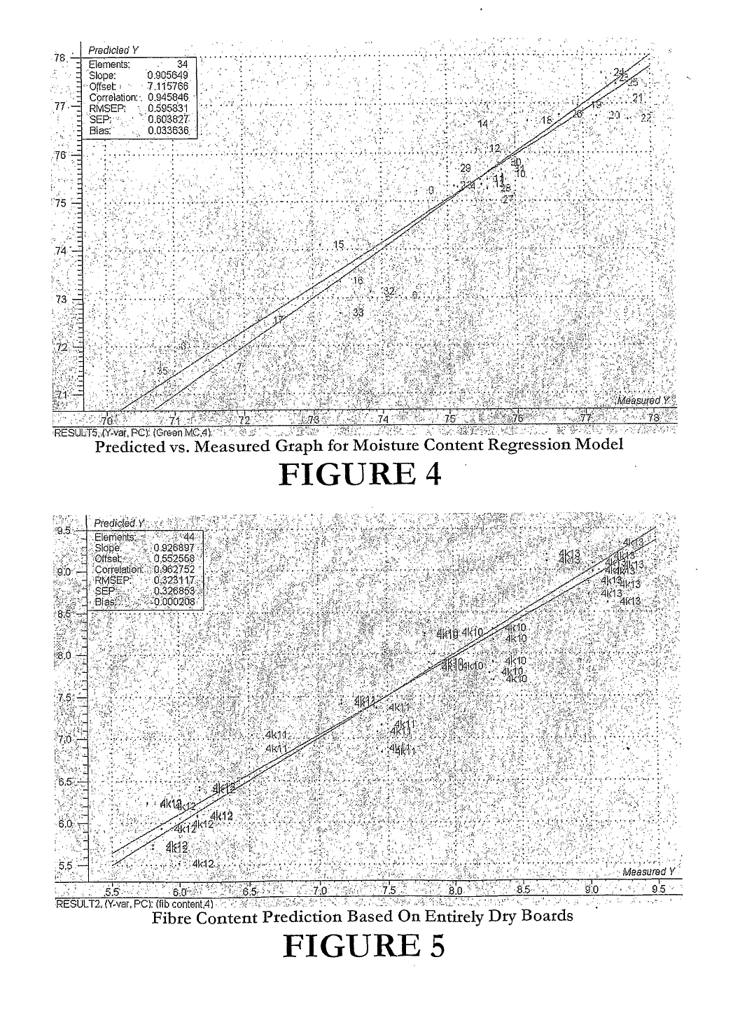

The changes in size roll pressure which were performed in the second trial make it possible to determine the ability of the NIR method to measure moisture content of the sheets. FIG. 4 shows the prediction of samples with different moisture contents (which also have different fibre contents).

The prediction shows a good fit for the predicted data, with a prediction error of 0.6%. The model is able to predict fibre content and moisture content independently of each other. A further indication of this was also found when the fibre content of oven dried panels was measured. For this purpose the autoclaved samples from the first trial where oven dried. They were then cooled in a desiccator and measured with the NIR instrument as quickly as possible to make sure they were entirely dry. FIG. 5 shows the fibre prediction results for these entirely dry samples.

The prediction model based on dry sheets, as shown in FIG. 5, shows a very similar prediction quality to the model based on green sheets (FIG. 3). The prediction quality has not deteriorated in the absence of water which shows that there is information in the spectra from the sheets which is responsive to the various levels of fibre content.

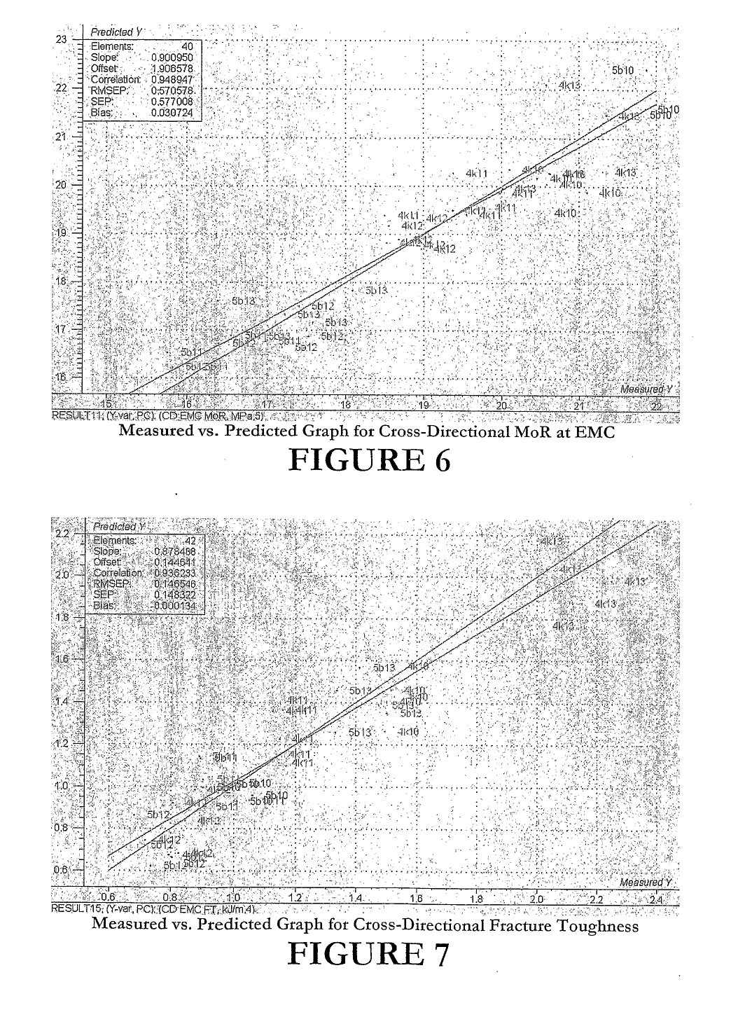

The spectral data was also used to create a prediction model for mechanical properties. FIG. 6 shows measured vs. predicted graph for cross-directional modulus of rupture (MoR) measured at 50±5% relative humidity and 23±2° C. The cross direction samples were used as they most closely corresponded to the NIR scanning location. There are significant cross-directional variations in the sheet fibre content. As before, both sets have been used together for the model building.

In FIG. 6 there is a relatively good correlation between predicted and measured MoR values (r=0.95) and also a fairly low prediction error of 0.57 MPa.

Another mechanical performance that was examined was the cross-directional fracture toughness. FIG. 7 gives the measured vs. predicted chart for this property. The prediction shows a prediction error of 0.15 kJ/m.

In the manufacture of fibre-cement composites NIR provides the opportunity to monitor the composition of product mix on-line and in real time. This would make it possible to reduce safety margins and pick up any unusual spikes or drifts in product composition. The necessity of assessing the finished product by wet chemistry and physical testing would be greatly reduced. Monitoring the product mix could also make it possible to predict the quality of the end product during the production stage.

Preferred embodiments of the invention have been described by way of example only and modifications may be made thereto without departing from the scope of the invention.

For example, the method and apparatus of the invention has been described for use with the Hatscheck process. However, it will be appreciated that the method or apparatus may be used with other fibre-cement processes such as the Mazza pipe process, the Magnini process, injection moulding, extrusion, hand lay-up, moulding, casting, filter pressing, fourdrinier forming, multi-wire forming, gap blade forming, gap roll/blade forming, bel-roll forming, wellcrete, and others.

The method and apparatus of the invention has been described for use in predicting the fibre content, moisture content, or mechanical properties of a fibre-cement board. However, it will be appreciated that the method and apparatus may be used to predict properties of other fibre-cement products, for example roofing tiles, mouldings, tile underlays or pipes.

1. An assessment method of a fibre-cement product in order to predict the fibre content of the product, to predict the moisture content of the product, or to predict mechanical properties of the product comprising:
obtaining a near-infrared spectra from the product to be assessed; and predicting the fibre content of the product, the moisture content of the product, or the mechanical properties of the product using multivariate regression analysis of the near-infrared spectra obtained.

2. The method of claim 1 which has the steps of:
subjecting the fibre-cement product to a source of near-infrared radiation, detecting the levels of reflected radiation over the near-infrared range or at a number of wavelengths in the near-infrared range, and analyzing the near-infrared reflectance spectra relative to stored comparative information on near-infrared reflectance data for fibre-cement product.

3. The method of claim 1 wherein the near-infrared radiation is of wavelength(s) in the range 1100-2500 nm.

4. The method of claim 1 wherein, the near-infrared spectra are obtained while the fibre-cement product is in a green state.

5. The method of claim 1 which includes assigning weighted factors to the spectra obtained and predicting the fibre content, moisture content, or mechanical properties by comparing the weighted factor to known weighted factors.

6. The method of claim 1 wherein the fibre-cement product is a fibre-cement board.

7. The method of claim 6 wherein the near-infrared spectra are obtained during manufacture when the thickness of the board is building up from a number of layers.

8. The method of claim 1 wherein the mechanical properties predicted are modulus of rupture or fracture toughness.

9. An assessment method of fibre-cement board in order to predict the fibre content of the board, to predict the moisture content of the board, or to predict mechanical properties of the board comprising:
obtaining a near-infrared spectra from the board to be assessed while the thickness of the board is building up from a number of layers; and predicting the fibre content of the board, the moisture content of the board, or the mechanical properties of the board using multivariate regression analysis the near-infrared spectra obtained.

10. An assessment method of fibre-cement board in order to predict the fibre content of the board, to predict the moisture content of the board, or to predict mechanical properties of the board comprising:
obtaining a near-infrared spectra from the board to be assessed while the thickness of the board is building up from a number of layers on a size roll; and predicting the fibre content of the board, the moisture content of the board, or the mechanical properties of the board using multivariate regression analysis of the near-infrared spectra obtained.

11. An apparatus for assessing fibre-cement board in order to predict the fibre content of the board, to predict the moisture content of the board, or to predict mechanical properties of the board comprising;
a source of near infra red radiation;
a near-infrared detector for obtaining, using such radiation, a near-infrared spectra from the board or from a part thereof as the thickness of the board is building up, the detector being mounted in association with a size roll; and
means for predicting the fibre content of the board, the moisture content of the board, or the mechanical properties of the board using multivariate regression analysis of the near-infrared spectra obtained.

12. The apparatus of claim 11 wherein there is means for analyzing the near-infrared reflectance spectra relative to stored comparative information on near-infrared reflectance data for fibre-cement board.

13. The apparatus of claim 11 wherein there is means for assigning weighted factors to the spectra obtained and predicting the fibre content, moisture content or the mechanical properties by comparing the weighted factor to known weighted factors.

14. The apparatus of claim 11 wherein the mechanical properties predicted are modulus of rupture or fracture toughness.

15. The method of claim 1 when substantially as herein described with reference to any one or more of the accompanying drawings.

16. The apparatus of claim 11 substantially as herein described with or reference to any one or more of the accompanying drawings.
